(19) United States
(12) Patent Application Publication
(10) Pub. No.: US 2006/0209830 A1
(43) Pub. Date: Sep. 21, 2006

(54) Packet processing system including control device and packet forwarding device

(75) Inventors: Naoki Oguchi, Kawasaki (JP); Tetsumei Tsuruoka, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/211,002

(22) Filed: Aug. 24, 2005

(30) Foreign Application Priority Data
Mar. 17, 2005 (JP) 2005-077948

(51) Int. Cl. H04L 12/28

(52) U.S. Cl. 370/392

(57) ABSTRACT

A packet processing system includes a plurality of control devices and a packet forwarding device that operate as a single packet forwarding device, each of the control devices executing at least one application. The packet processing system transmits, when a destination of a packet specified by an application is within the packet processing system, the packet from the application to the destination directly without using the packet forwarding device.

### CROSS-REFERENCE TO RELATED APPLICATIONS

Cooperated with U.S. patent application Ser. No. 10/887901 filed on Jul. 12, 2004.

### BACKGROUND OF THE INVENTION

1. Field of the Invention

The present invention relates to a technology for transmitting data packet within a packet processing system including a plurality of control devices (such as servers) and a packet forwarding device (such as a router) that operate as a single packet forwarding device.

2. Description of the Related Art

In recent years, growing use and development of the Internet is requiring for further upgrading of the functions provided by a network. A server connected to the Internet executes applications that implement various types of services. On the other hand, there is a case which is desirable to execute various programs on a device, which carries out packet forwarding on the Internet, for example, a router.

To show the system as if a single host is providing a plurality of services, a packet forwarding device and a group of servers need to be operated in a way so that the packet forwarding device and the servers appear to constitute a single host to an outside system.

A virtual interface technology is disclosed in Japanese Patent Application No. 2003-209266 in which the an external server links to a packet forwarding device, thereby enabling the external server to execute a process delegated by the packet forwarding device, so that the process appears to be executed as if on a single virtual host. Thus, performance of the overall system is enhanced by the virtual interface technology described in above patent.

According to the virtual interface technology, in a system consisting of servers and the packet forwarding device, the interface existing in the packet forwarding device is shown as an interface existing on the server itself (a virtual interface) for a program or a process that runs on a server. When the program or the process on the server carries out communication with an external terminal via the virtual interface, a packet, which is to be transmitted using the virtual interface, is transmitted to the packet forwarding device, and is transmitted via the corresponding interface of the packet forwarding device. A packet received from the interface of the packet forwarding device is transferred to a server having the corresponding virtual interface, and then distributed to the program or the process on the server as if received via the virtual interface. Thus, the program or the process that runs on the server behaves as if running on the packet forwarding device. The process can be distributed and executed by a server having a high computation performance. Thus, high performance can be acquired by distribution processes to servers and using a high performance computation resources on those servers.

Usually, the program or the process, which carries out communication via the network, uses an application interface called socket API. In the virtual interface technology, by intervening in a sequence to generate a socket for the virtual interface, a packet transfer path is established between the program or the process that is generating the socket and the packet forwarding device having an actual interface corresponding to the virtual interface. Thus, the packet can be sent or received via the virtual interface.

Accordingly, when programs or processes that are executed by separate servers are to be shown as if running on the packet forwarding device to an external terminal, the correspondence between the socket and the actual executing server is managed by the packet forwarding device when each program or process is generating the socket, and a communication path is established between the packet forwarding device and the server for each socket. When the packet forwarding device receives a packet via the virtual interface, the packet can be distributed to the corresponding server via the communication path corresponding to the incoming socket for the packet. Thus, to an external terminal, the programs executed by separate servers appear to be executed by a single server consisting of the packet forwarding device and each of the servers.

However, carrying out communication between the programs or the processes within a device presents problems. A network socket API can be used for communication between separate hosts as well as for communication between programs or processes inside the same host, by creating a socket which has an address of itself as the destination address. The network socket API is widely used for communication between the programs or the processes inside the same host because remote programs or processes and local programs or processes can be conveniently used without making a distinction between the two.

When applying a program which uses the network socket API to carry out communication between the programs or the processes inside the same host to the aforementioned structure, the programs or the processes communicating with each other need to be shown as running on the packet forwarding device. Thus, when the two programs or the two processes open the sockets, destination address that specifies a destination host must be one and the same address indicating the virtual interface of the server that corresponds to the interface of the packet forwarding device that is supposedly executing the programs or the processes. Or, the two addresses must be one and the same identifier indicating the packet forwarding device itself.

Even when the programs or the processes that carry out communication with each other are to be executed on the same external server, because the interface of the server and the interface of the packet forwarding device are connected with a tunnel, communication between them is carried out via paths between the server and the packet forwarding device that correspond to the socket opened by each of the programs or the processes. Thus, the communication, although within the same host, is carried out using paths via the packet forwarding device, thereby resulting in a processing overhead and affecting the efficiency.

When the programs or the processes that carry out communication with each other are to be executed from separate external servers, the communication is carried out via the virtual interface and the socket tunnels, thereby resulting in a higher transmission overhead as compared to when the communication is carried out directly between the two servers. Particularly, even when there is a path between the two servers that can be used for communication between them without resorting to the packet forwarding device, the communication is carried out via the packet forwarding device, thereby resulting in a processing overhead and affecting the efficiency.

### SUMMARY OF THE INVENTION

A packet processing system according to an aspect of the present invention includes a plurality of control devices and a packet forwarding device that operate as a single packet forwarding device, each of the control devices executing at least one application. The packet processing system includes: a transmission table that stores data for a packet transmission within the packet processing system; a determining unit that determines whether a destination for a packet specified by an application is within the packet processing system based on the transmission table; and a transmission unit that transmits, when the determining unit determines that the destination is within the packet processing system, the packet from the application to the destination directly without using the packet forwarding device.

A method according to another aspect of the present invention is a method of transmitting a packet in a packet processing system including a plurality of control devices and a packet forwarding device that operate as a single packet forwarding device, each of the control devices executing at least one application. The method includes: determining whether a destination for a packet specified by an application is within the packet processing system, based on a transmission table that stores data for a packet transmission within the packet processing system; and transmitting, when it is determined that the destination is within the packet processing system at the determining, the packet from the application to the destination directly without using the packet forwarding device.

A computer-readable recording medium according to still another aspect of the present invention stores a computer program that causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a drawing illustrating a packet transmission within a router by means of a conventional router;

FIG. 1B is a drawing illustrating the packet transmission within the router by means of a router according to a first and a second embodiments of the present invention;

FIG. 2 is a block diagram of the router according to the first embodiment;

FIG. 3A is a drawing of a transmission table stored in a control device A;

FIG. 3B is a drawing of a transmission table stored in a control device B;

FIG. 4 is a drawing of a distribution table;

FIGS. 5A and 5B are flowcharts of a sequence of a packet transmission process between control devices by the router according to the first embodiment;

FIG. 6 is a block diagram of the control device according to the second embodiment;

FIG. 7 is a drawing of an application table;

FIGS. 8A and 8B are flowcharts of a sequence of a packet transmission process within the control device by a packet processing device according to the second embodiment;

FIG. 9 is a block diagram of hardware of the control device according to the first and the second embodiments.

FIG. 10 is a diagram illustrating the packet format of a transmission request message;

FIG. 11 is a diagram illustrating the packet format of a transmission response message;

FIG. 12 is a diagram illustrating the packet format of a path request message;

FIG. 13 is a diagram illustrating the packet format of a path response message;

FIG. 14 is a diagram illustrating the packet format of a path confirmation request message; and

FIG. 15 is a diagram illustrating the packet format of a path confirmation response message.

### DETAILED DESCRIPTION OF THE PREFERRED EMBODIMENTS

Exemplary embodiments of the present invention are explained next with reference to the accompanying drawings. A packet transmission between control devices of a router consisting of a packet forwarding device and two control devices is explained in a first embodiment. The packet transmission within a single control device is explained in a second embodiment. The present invention is not limited to these embodiments.

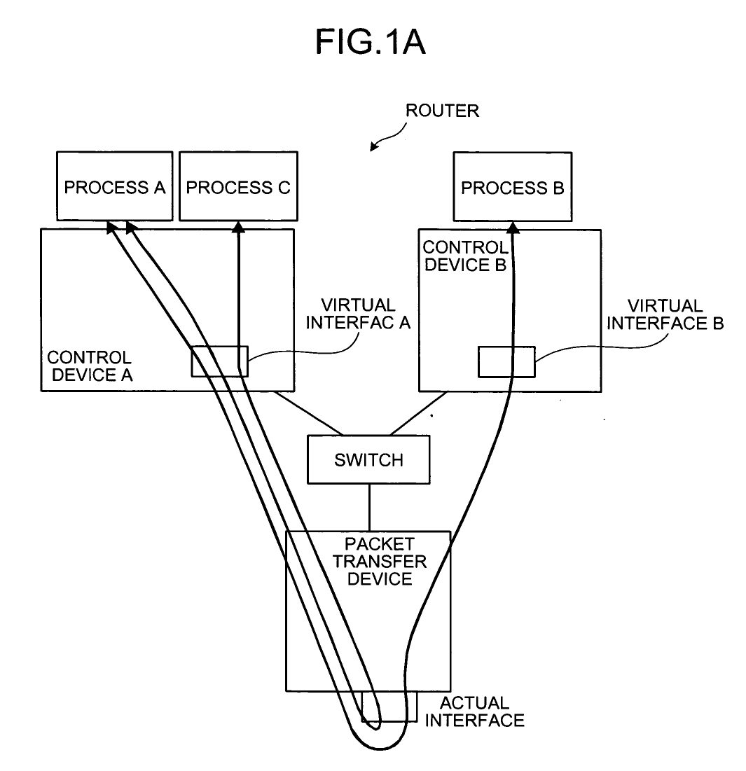

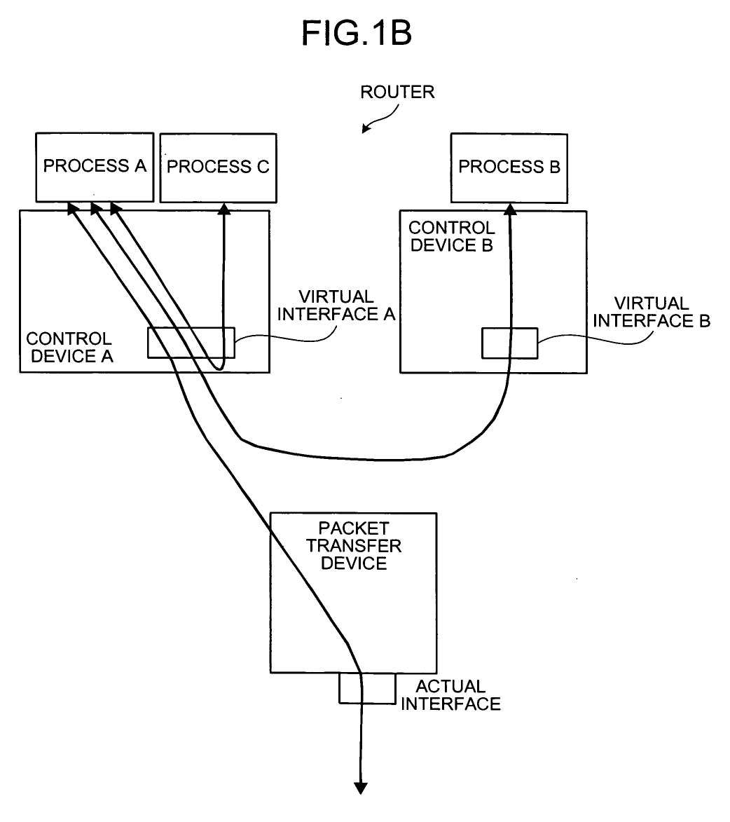

The packet transmission within the router by the router according to the first and the second embodiments is explained first with reference to FIG. 1A and FIG. 1B. FIG. 1A is a drawing illustrating the packet transmission within the router by means of a conventional router. FIG. 1B is a drawing illustrating the packet transmission within the router by means of the router according to the first and the second embodiments.

As shown in FIG. 1A, in the conventional router that includes a control device A and a control device B, when a packet is to be transmitted between a process A executed by the control device A and a process B executed by the control device B, because the communication is carried out via a virtual interface and a socket tunnel, the packet is first sent to a packet forwarding device and then sent to the recipient control device from the packet forwarding device.

As shown in FIG. 1B, in the router according to the first embodiment, when both the control devices include a path which can be used for communication without the need to communicate via the packet forwarding device, the packet transmitted between the process A executed by the control device A and the process B executed by the control device B is transmitted directly between the control devices without being transmitted via the packet forwarding device.

In other words, in the router according to the first embodiment, when transmitting the packet between the control devices within the router, the packet is transmitted without being sent to the packet forwarding device, thereby reducing the transmission overhead and enabling the packet to be transmitted efficiently.

As shown in FIG. 1A, in the conventional router, when transmitting a packet between the process A and a process C that are executed by the control device A, because the communication is carried out via the virtual interface and the socket tunnel, the packet is first sent to the packet forwarding device and then redirected to the control device A from the packet forwarding device.

As shown in FIG. 1B, in the router according to the second embodiment, the control device A directly transmits the packet between the processes without sending the packet via the packet forwarding device. In other words, in the router according to the second embodiment, when transmitting the packet within a control device, the packet is transmitted without being sent via the packet forwarding device, thereby reducing the transmission overhead and enabling to transmit the packet efficiently.

To be specific, when a virtual interface driver of each of the control devices receives from an upper layer a transmission packet having the same destination address as the address of the virtual interface, the virtual interface driver determines whether a destination process exists in the same control device. If the destination process exists in the same control device, the packet is directed to the destination process via the virtual interface. If the destination process does not exist in the same control device, the virtual interface driver inquires whether the destination process exists in the other control device that is mounting same actual interface of the packet forwarding device. If the destination process exists in the other control device, the virtual interface driver changes the destination address of the packet to the address of the other control device and sends the packet directly to the other control device. If the destination process does not exist in the other control device, the virtual interface driver discards the packet and returns an error message to the system call.

Thus, the virtual interface driver of each control device transmits the packet based on whether the destination process exists in the router system which consisted of packet forwarding device and control devices and in which control device the destination process exists, thereby enabling to efficiently carry out packet transmission in the router system.

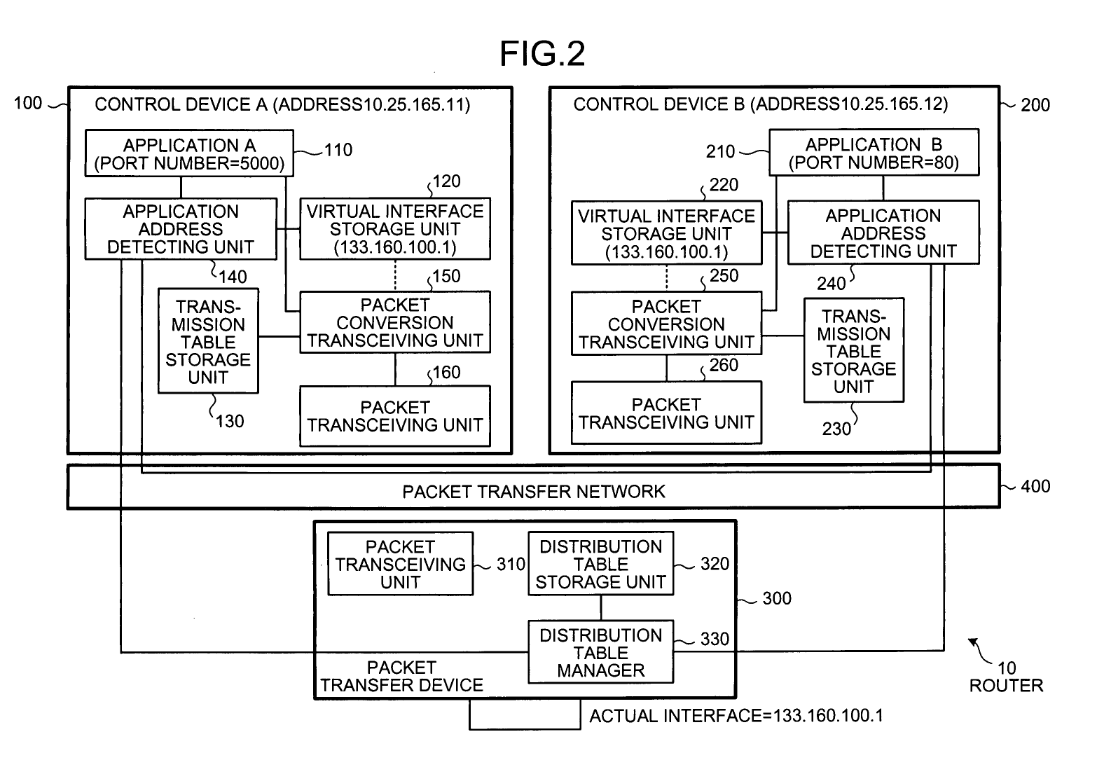

A structure of the router according to the first embodiment is explained next. FIG. 2 is a block diagram of the router according to the first embodiment. As shown in FIG. 2, a router 10 includes a control device A 100 and a control device B 200 that execute applications, and a packet forwarding device 300. The control device A 100, the control device B 200, and the packet forwarding device 300 are connected via a packet transfer network 400.

Although only two control devices are shown in the present embodiment for the sake of convenience, a random number of control devices can be included in the router 10. Path computation is used as an example of an application executed by the control devices.

The control device A 100 includes an application A 110, a virtual interface storage unit 120, a transmission table storage unit 130, an application address detecting unit 140, a packet conversion transceiving unit 150, and a packet transceiving unit 160. The control device B 200 also includes similar functioning units.

The application A 110 is executed by the control device A 100 and carries out transceiving of the packet between itself and an application B 210 executed by the control device B 200.

The virtual interface storage unit 120 stores a virtual interface address. To be specific, the virtual interface storage unit 120 stores “133.160.100.1”, which is an IP address of the packet forwarding device 300, as the virtual interface address. “10.25.165.11” is an IP address of a network interface that connects the control device A 100 to the packet transfer network 400, and “10.25.165.12” is an IP address of a network interface that connects the control device B 200 to the packet transfer network 400.

In other words, the control device A 100 and the control device B 200, together with the packet forwarding device 300, constitute the logically single router 10. Because the control device A 100 and the control device B 200 carry out communication with an external terminal by means of an actual interface provided by the packet forwarding device 300, the communication with the external terminal is carried out by means of the virtual interface instead of the actual IP address.

The transmission table storage unit 130 stores a transmission table that establishes and records a correspondence between a destination application address consisting of an IP address and a port number, and the IP address of the control device, which is the destination of the packet having the destination application address.

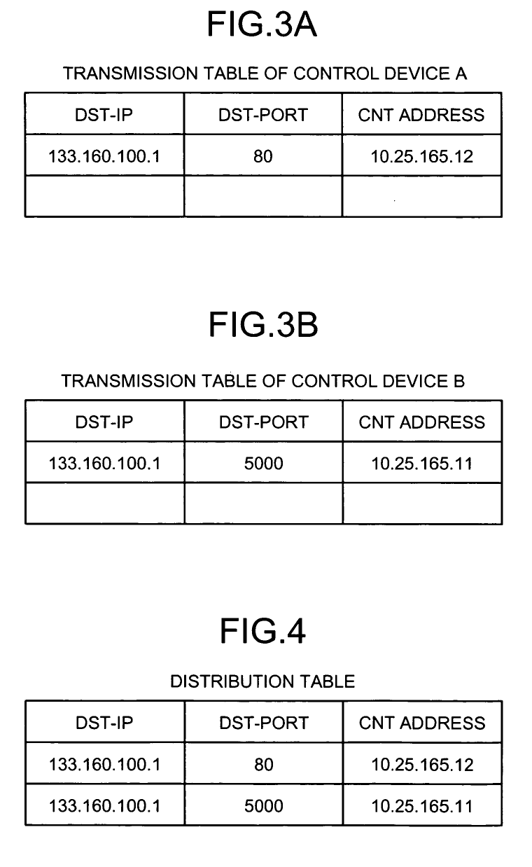

FIG. 3A is a drawing of the transmission table stored in the control device A 100, and FIG. 3B is a drawing of the transmission table stored in the control device B 200. The transmission tables shown in FIG. 3A and FIG. 3B are generated when the application A 110 uses a port number “5000” and the application B 210 uses a port number “80” to carry out packet transmission between each other.

As shown in FIG. 3A and FIG. 3B, each entry in the transmission table consists of a DST-IP, a DST-PORT, and a CNT address. The DST-IP is the destination IP address, the DST-PORT is the destination port number, and the CNT address is the IP address of the control device. In other words, the packet that includes the destination application address specified by the DST-IP and the DST-PORT is directly transmitted to the control device specified by the CNT address without being transmitted via the packet forwarding device 300.

For example, as shown in FIG. 3A, the DST-IP “133.160.100.1” is the same as the virtual interface. When the application A 110 requests transmission of the packet which includes the destination application address having the DST-PORT “80”, the packet is directly transmitted to the control device having the IP address “10.25.165.12”, in other words, to the control device B 200.

The application A 110 generates a communication port and sets a destination application address, which is detected by the application address detecting unit 140. If the destination IP address is the same as the virtual interface address stored in the virtual interface storage unit 120, the application address detecting unit 140, in collaboration with the packet forwarding device 300 and the control device B 200, records in the transmission table stored in the transmission table storage unit 130, the correspondence between the destination application address and the IP address of the destination control device.

In other words, when a communication port for carrying out communication within the router 10 is generated, the application address detecting unit 140 records in the transmission table stored in the transmission table storage unit 130, the correspondence between the destination application address and the IP address of the destination control device.

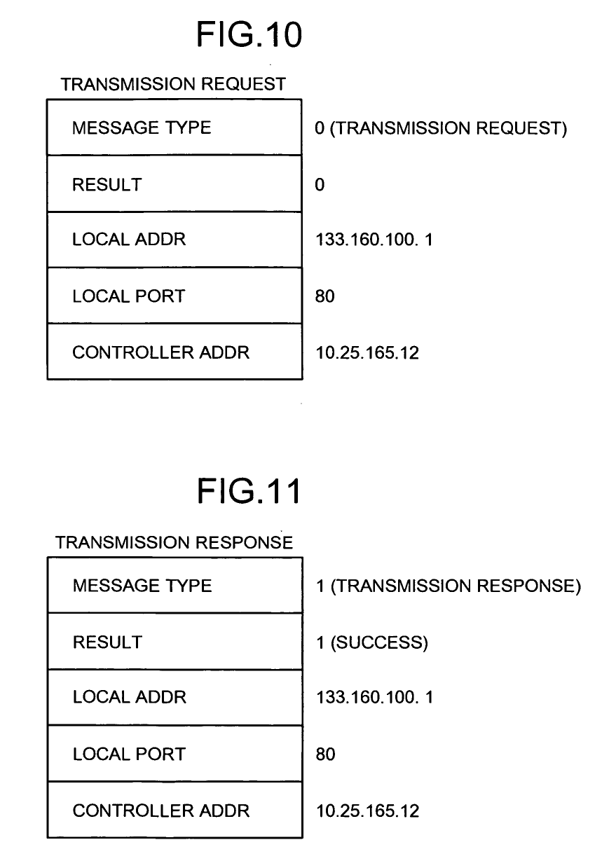

To be specific, when the application A 110 sets a local address, in other words, a source application address (the IP address and the port number of the control device A 100) in the socket, the application address detecting unit 140 sends a transmission request message to the packet forwarding device 300. FIG. 10 shows the packet format of a transmission request message. The transmission request message includes the source application address and the destination application address (the IP address and the port number of the destination control device) of the application A 110.

When the packet forwarding device 300 and the control device B 200 determine the IP address of the destination control device that corresponds to the destination application address, a correspondence is established between the IP address of the destination control device and the destination application address and recorded in the transmission table. A sequence of a process to record in the transmission table, the correspondence between the IP address of the destination control device and the destination application address is explained in detail later.

The packet conversion transceiving unit 150 receives the transmission packet from the application A 110 and if the destination of the packet is the other control device within the router 10, transmits the packet directly to the destination control device without transmission via the packet forwarding device 300.

In other words, if the destination IP address included in the destination application address of the transmission packet matches with the virtual interface address, the packet conversion transceiving unit 150 searches the transmission table to get the IP address of the destination control device and transmits the transmission packet via the packet transceiving unit 160, to the destination control device.

If the destination IP address included in the destination application address of the transmission packet does not match with the virtual interface address, the packet conversion transceiving unit 150 uses the virtual interface address to transmit the transmission packet via the packet transceiving unit 160.

The packet conversion transceiving unit 150 receives the transmission packet from the other control device via the packet transceiving unit 160 and based on the destination application address distributes the received packet to the application.

The packet transceiving unit 160 transmits a packet to and receives a packet from the other control device via the packet transfer network 400. The packet transceiving unit 160 transmits a packet to the packet forwarding device 300 and the other control device, and receives a packet from the packet forwarding device 300 and the other control device.

The packet forwarding device 300 transmits a packet to and receives a packet from an external device via the network. The packet forwarding device 300 transmits the received packet to other routers etc. by means of a routing table. The IP address of the packet forwarding device 300 is “133.160.100.1” which is used as the virtual interface address. The packet forwarding device 300 includes a packet transceiving unit 310, a distribution table storage unit 320, and a distribution table manager 330.

The packet transceiving unit 310 transmits the packet received from a control device via the packet transfer network 400 to an external terminal by means of an actual interface, and transmits the packet received from the external terminal via the packet transfer network 400 to the control device by means of the actual interface.

The distribution table storage unit 320 stores a distribution table that records the data necessary for the formation of the transmission table. Each control device generates a transmission table based on the data in the distribution table. Data pertaining to the transmission tables of all the control devices is recorded in the distribution table.

FIG. 4 is a drawing of the distribution table. As shown in FIG. 4, like the transmission table, a correspondence, between the destination application address consisting of the IP address and the port number, and the IP address of the destination control device of the packet that includes the destination application address, is recorded in the distribution table.

The distribution table manager 330 manages the distribution table stored in the distribution table storage unit 320. The distribution table manager 330, upon receiving a transmission request message from a control device, generates and records an entry in the distribution table.

To be specific, the distribution table manager 330 searches the distribution table by means of the source application address included in the transmission request message. If there is no entry in the distribution table, the distribution table manager 330 generates a new entry by taking the source IP address included in the transmission request message as the DST-IP, the source port number as the DST-PORT, the source application IP address as the CNT address, and records the new entry in the distribution table. The distribution table manager 330 sends a transmission reply message to the control device notifying the recording of the new entry in the distribution table. If there is an entry in the distribution table, the distribution table manager 330 sends a transmission reply message notifying an error to the control device.

The distribution table manager 330 can accumulate the data necessary for the formation of the transmission table in the distribution table by receiving the transmission request message from the control device and generating an entry in the distribution table.

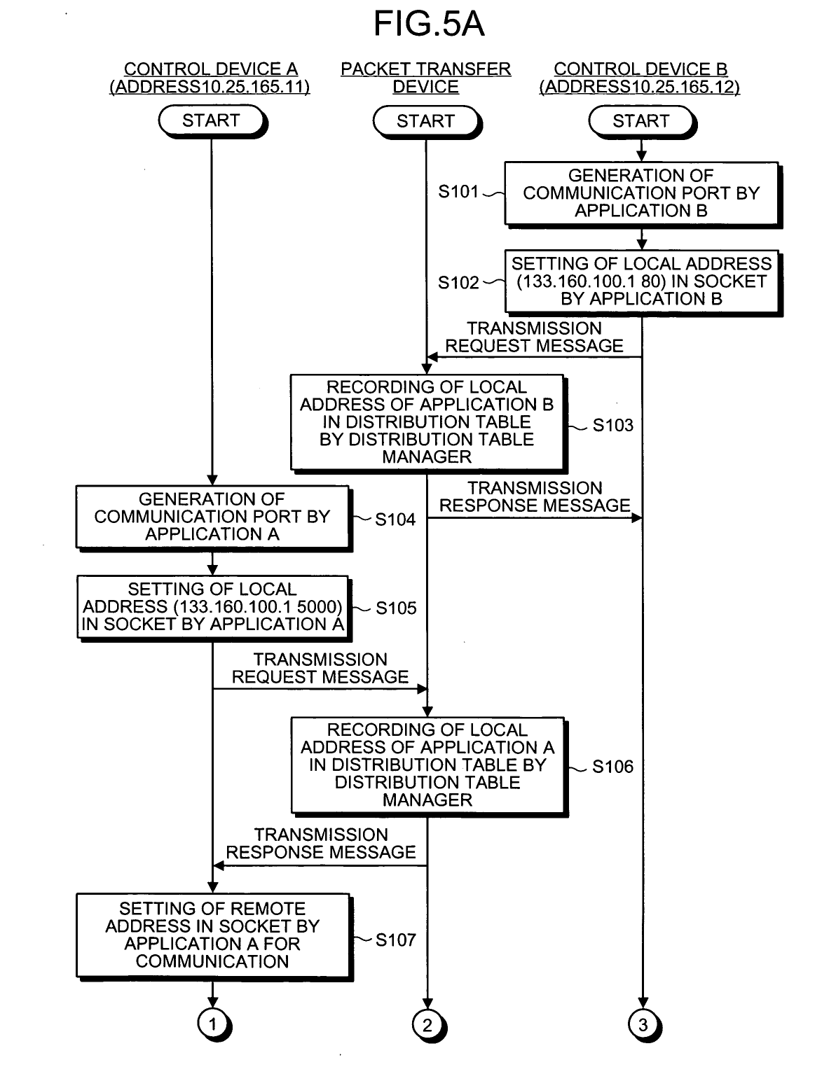

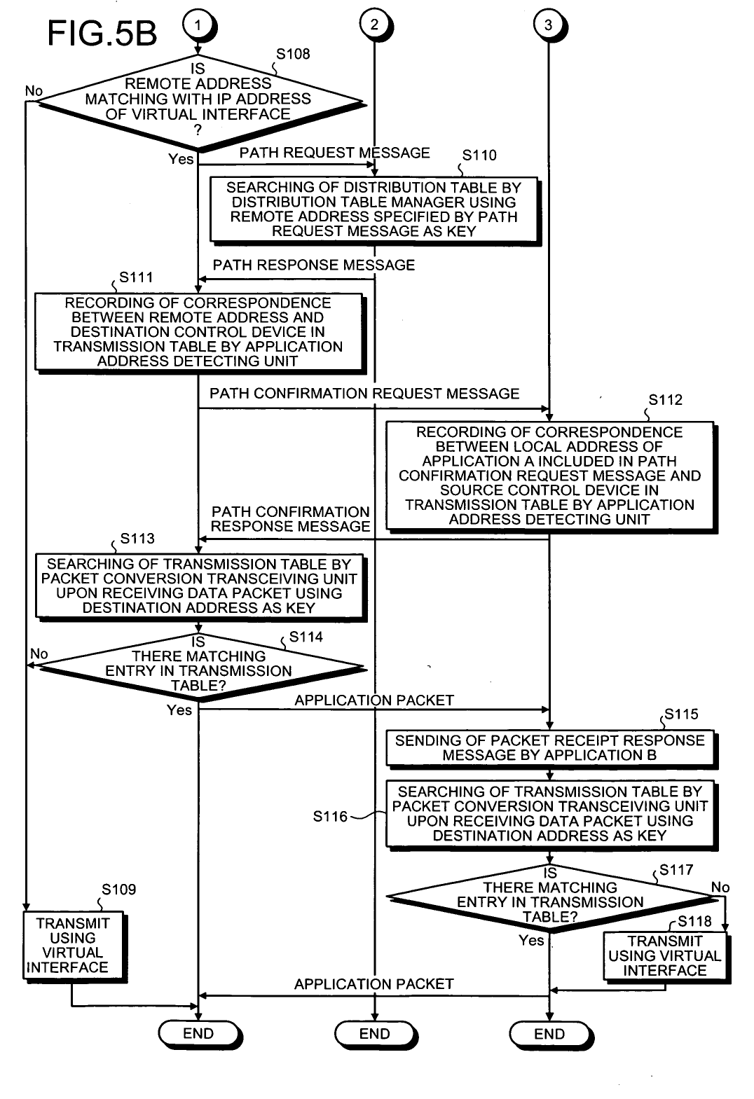

A sequence of a packet transmission process between the control devices according to the first embodiment is explained next. FIG. 5A and FIG. 5B are flowcharts of the sequence of the packet transmission process between the control devices according to the first embodiment.

The sequence is explained in which the application B 210 executed by the control device B 200 generates a communication port, and next, the application A 110 executed by the control device A 100 generates a communication port and sends the packet to the application B 210 by means of the virtual interface.

As shown in FIG. 5A, in the router 10, the application B 210 generates the communication port (step S101) and sets the local address “133.160.100.1 80” in the socket (step S102).

An application address detecting unit 240, upon detecting an application address that matches with the virtual interface address, sends a transmission request message to the distribution table manager 330 of the packet forwarding device 300. FIG. 10 shows the packet format of a transmission request message.

The distribution table manager 330 of the packet forwarding device 300, upon receiving the transmission request message, records the local address (source application address) of the application B 210 in the distribution table (step S103), and sends a transmission response message to the application address detecting unit 240 of the control device B 200. FIG. 11 shows the packet format of a transmission response message.

Next, the application A 110 of the control device A 100 generates the communication port to carry out communication with the application B 210 (step S104) and sets the local address (source application address) “133.160.100.1 5000” in the socket (step S105).

The application address detecting unit 140, upon detecting the source application address that matches with the virtual interface address, sends a transmission request message to the distribution table manager 330 of the packet forwarding device 300.

The distribution table manager 330 of the packet forwarding device 300, upon receiving the transmission request message, records the local address (source application address) of the application A 110 in the distribution table (step S106), and sends a transmission response message to the application address detecting unit 140 of the control device A 100.

When the application A 110 specifies a remote address (destination application address) to the socket for communication (step S107), the application address detecting unit 140 determines whether the remote address matches with the virtual interface address (step S108). If the remote address does not match with the virtual interface address, the packet transceiving unit 160, upon receiving the data packet, transmits the packet by means of the virtual interface (step S109).

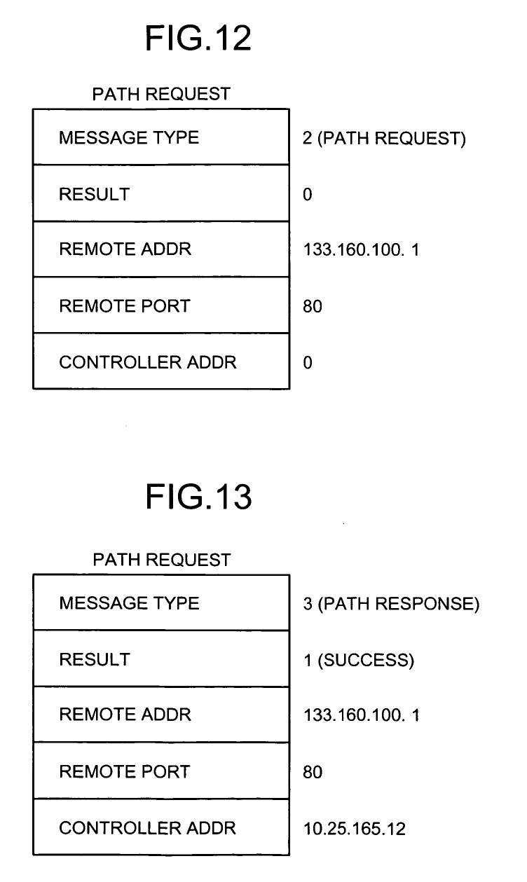

If the remote address matches with the virtual interface address, the application address detecting unit 140 sends a path request message to the distribution table manager 330 of the packet forwarding device 300. The remote address is included in the path request message. FIG. 12 shows the packet format of a path request message.

The distribution table manager 330 of the packet forwarding device 300, upon receiving the path request message, searches in the distribution table, an entry that matches with the remote address of the path request message (step S110). If the entry pertaining to the application B 210 matches with the remote address, the distribution table manager 330 includes in the path response message the IP address of the control device B 200 that is running the application B 210 and sends the path response message to the control device A 100. FIG. 13 shows the packet format of a path response message.

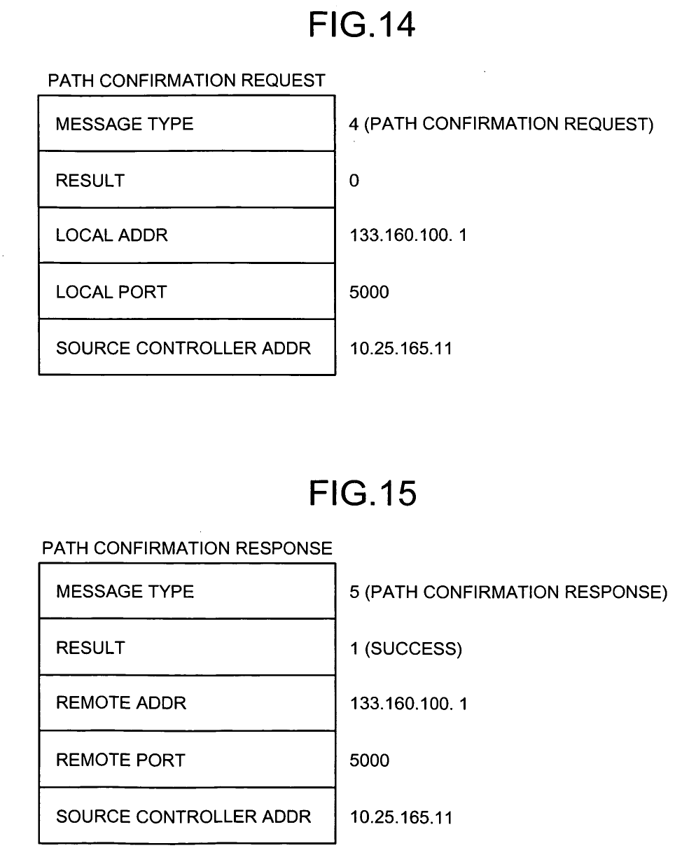

The application address detecting unit 140 of the control device A 100, upon receiving the path response message, writes the correspondence between the remote address and the IP address of the control device B 200 in the transmission table (step S111) and sends a path confirmation request message to the control device B 200. The local address is included in the path confirmation request message. FIG. 14 shows the packet format of a path confirmation request message.

The application address detecting unit 240 of the control device B 200, upon receiving the path confirmation request message, records in the transmission table, the correspondence between the local address of the application A 110 and the IP address of the control device A 100 (step S112), and sends a path confirmation response message to the control device A 100. FIG. 15 shows the packet format of a path confirmation response message.

When the application A 110 of the control device A 100 transmits the data packet, the packet conversion transceiving unit 150, which receives the data packet, searches the transmission table with the destination IP address as a key (step S113) and determines whether there is a matching entry in the transmission table (step S114).

If there is no matching entry in the transmission table, the packet transceiving unit 160 transmits the packet by means of the virtual interface (step S109). If there is a matching entry in the transmission table, the application packet (data packet) is transmitted via the packet transceiving unit 160 to the control device specified by the CNT address of the matching entry.

A packet transceiving unit 260 of the control device B 200 receives the application packet and upon detecting that the packet has the virtual interface address, distributes the packet to a packet conversion transceiving unit 250. Next, the packet conversion transceiving unit 250 distributes the packet to the application B 210 based on the destination application address of the application packet.

The application B 210 of the control device B 200 transmits an application packet to the packet conversion transceiving unit 250 in response to the application packet from the control device A 100 (step S115).

Next, the packet conversion transceiving unit 250 searches the transmission table with the destination application address of the application packet as a key (step S116) and determines whether there is a matching entry in the transmission table (step S117).

If there is a matching entry in the transmission table, the application packet is transmitted via the packet transceiving unit 260 to the control device specified by the CNT address of the matching entry. If there is no matching entry in the transmission table, the application packet is transmitted via the packet transceiving unit 260 by means of the virtual interface (step S118).

Thus, in the first embodiment, the application address detecting unit of each control device, in collaboration with the packet forwarding device 300 and the application address detecting unit of the other control device, generates and stores in a transmission table storage unit, a transmission table which records the destination of the packet that is transmitted between the control devices in the router 10. A packet conversion transceiving unit, upon receiving a packet having a destination application address that matches with the virtual interface address stored in a virtual interface storage unit, directly transmits the packet to the other control device based on the transmission table. Thus, a packet can be efficiently transmitted between the control devices in the router 10.

A router consisting of control devices and a packet forwarding device is explained in the first embodiment. The present invention can be similarly applied to a web service provider consisting of a load balancer and a plurality of servers.

However, in the Web service provider, a proxy IP address is used instead of a virtual interface address when a client device accesses the Web service provider. Each server establishes a correspondence between the proxy IP address and the IP address of the server itself, and the IP address of the server is stored as a proxy IP correspondence address. The proxy IP correspondence address is stored in the DST-IP of the transmission table instead of a virtual IP address.

Each control device, when specifying the proxy IP correspondence address as a local address to send a transmission request message to the packet forwarding device, changes the “proxy IP correspondence address” to the corresponding “proxy IP address”. Each control device, upon an application specifying a remote address of a destination, sends a path request message if the remote address matches with the proxy IP correspondence address. When sending the path request message, the remote address included in the path request message is changed to the proxy IP address.

Moreover, by generalizing a router or a Web service provider, the present invention can also be similarly applied to various packet processing devices consisting of a packet forwarding device and a plurality of servers. A self-node identification data that identifies the node (device) itself needs to be used instead of a virtual interface address or a proxy IP address.

Recording the corresponding entry in the transmission table when the application specifies a remote address to the socket for communication is explained in the first embodiment. The application specifies the remote address when the application process call a connection generating procedure to the destination application process, or when the application process call a packet transmission procedure.

The first embodiment is explained assuming the existence of a physical communication path between the control devices. Moreover, whether the communication path exists may be checked before recording the corresponding entry in the transmission table. To be specific, a reachability checking packet is transmitted from the control device A to the control device B, and the corresponding entry can be recorded in the transmission table only upon receiving a response from the control device B.

A packet transmission between applications that are executed by the same control device is explained in the second embodiment. A structure of the control device according to the second embodiment is explained first. A router is generalized and explained as a packet processing device consisting of a packet forwarding device and two control devices.

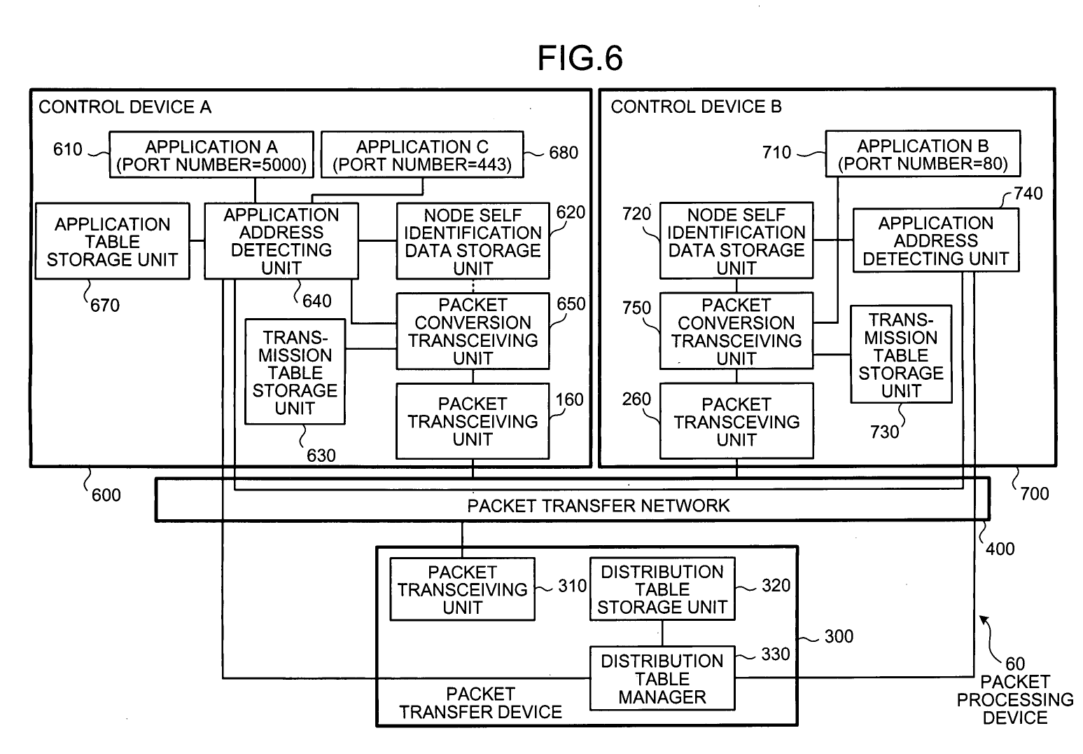

FIG. 6 is a functional block diagram of the control device according to the second embodiment. For the sake of convenience, a unit, which performs a similar function as a unit shown in FIG. 2, is indicated by the same reference numeral, and the detailed explanation is omitted.

As shown in FIG. 6, a control device A 600 includes an application A 610, a self-node identification data storage unit 620, a transmission table storage unit 630, an application address detecting unit 640, a packet conversion transceiving unit 650, the packet transceiving unit 160, an application table storage unit 670, and an application C 680.

The application A 610 and the application C 680 are executed as processes by the control device A 600 and carry out transceving of a packet between each other. The self-node identification data storage unit 620 stores a self-node identification data that identifies a packet processing device 60. All the control devices in the packet processing device 60 include the same self-node identification data.

The transmission table storage unit 630 establishes and stores in a transmission table, a correspondence between a destination application address having other application in the control device A 600 as the destination, and the IP address of the control device A 600.

The application table storage unit 670 stores an application table and records a correspondence between a process number of an application and a port number used by the application.

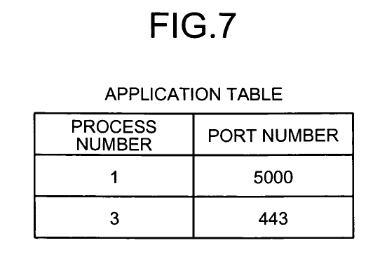

FIG. 7 is a drawing of the application table. As shown in FIG. 7, a process having a process number “1” corresponds to the application A 610, and a process having a process number “3” corresponds to the application C 680.

The application address detecting unit 640 records in the transmission table, the local addresses of the application A 610 and the application C 680 by means of the application table stored in the application table storage unit 670.

To be specific, when an application generates a communication port and sets a local address in a socket, the application address detecting unit 640 sends a transmission request message to the packet forwarding device 300. Both the application A 610 and the application C 680 that carry out the communication send a transmission request message to the packet forwarding device 300. Next, either the application A 610 or the application C 680 sets a remote address in the socket and if the remote address matches with the self-node identification data, the local addresses of the application A 610 and the application C 680 are recorded in the transmission table. A sequence of a process to record the local address of the application in the transmission table is explained later.

The packet conversion transceiving unit 650 receives the transmission packet from the application A 610, and if the destination of the transmission packet is the other application executed by the same control device, transmits the package by loop back.

In other words, if there is an entry in the transmission table that matches with the destination application address of the transmission packet and if the destination control device is the same control device, the packet conversion transceiving unit 650 transmits the transmission packet by loop back.

The packet conversion transceiving unit 650 determines whether the packet transmission is within the same control device by means of the transmission table. If the packet transmission is within the same control device, the packet conversion transceiving unit 650 transmits the packet by loop back. Thus, packet transmission within the same control device can be carried out efficiently.

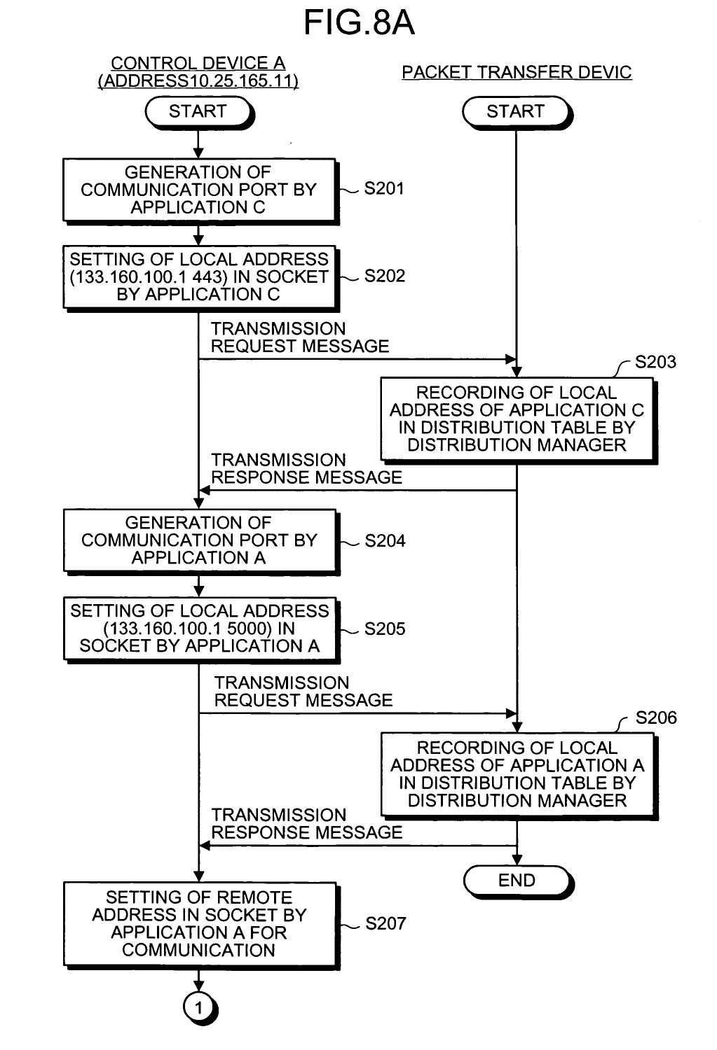

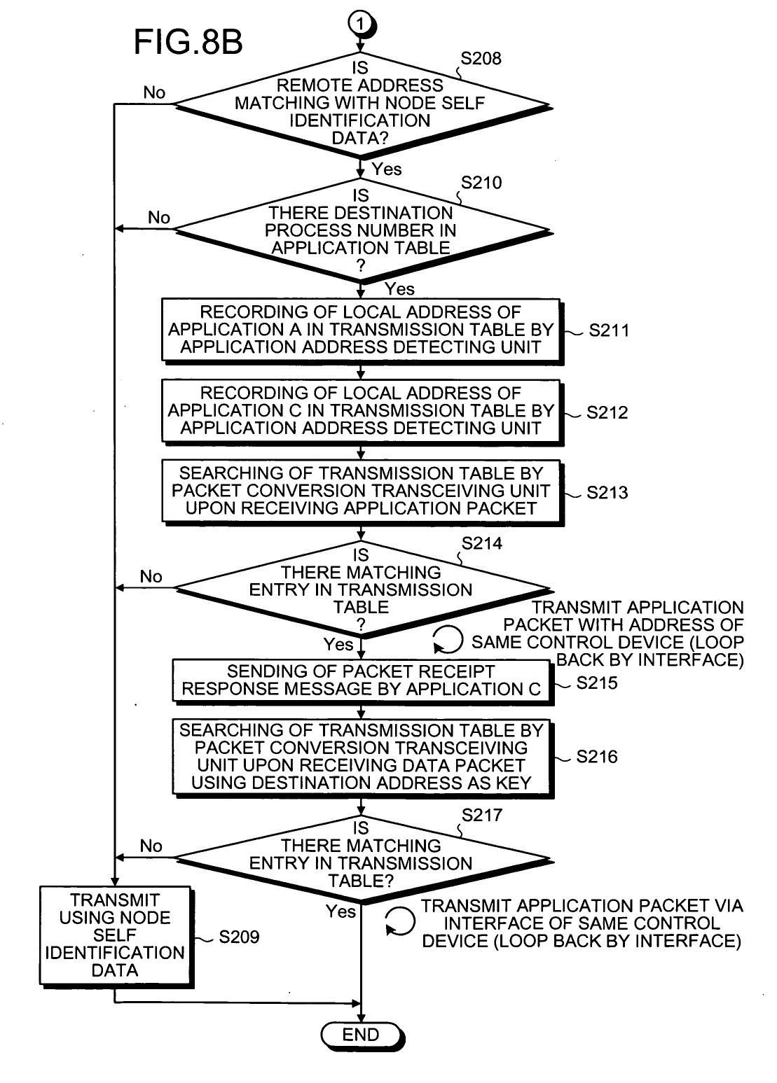

A sequence of a packet transmission process within the control device by the packet processing device 60 according to the second embodiment is explained next. FIG. 8A and FIG. 8B are flowcharts of the packet transmission process within the control device by the packet processing device 60 according to the second embodiment. The sequence is explained when the application A 610 and the application C 680 which are executed by the control device A 600 carry out communication with each other.

As shown in FIG. 8A and FIG. 8B, the application C 680 of the packet processing device 60 generates a communication port (step S201) and sets a local address “10.25.165.11 443” in the socket (step S202).

The application address detecting unit 640, upon detecting an application address that matches with the self-node identification data, sends a transmission request message to the distribution table manager 330 of the packet forwarding device 300.

The distribution table manager 330 of the packet forwarding device 300, upon receiving the transmission request message, records the local address of the application C 680 in the distribution table (step S203) and sends a transmission response message to the application address detecting unit 640.

Next, the application A 610 generates a communication port to carry out communication with the application C 680 (step S204) and sets the local address (source application address) “10.25.165.11 5000” in the socket (step S205).

The application address detecting unit 640, upon detecting a source application address that matches with the self-node identification data, sends a transmission request message to the distribution table manager 330 of the packet forwarding device 300.

The distribution table manager 330 of the packet forwarding device 300, upon receiving the transmission request message, records the local address of the application A 610 in the distribution table (step S206) and sends a transmission response message to the application address detecting unit 640.

The application A 610 specifies a remote address (destination application address) in the socket for communication (step S207) and the application address detecting unit 640 determines whether the remote address matches with the self-node identification data (step S208). If the remote address does not match with the self-node identification data, the packet transceiving unit 160, upon receiving the application packet, transmits the packet by means of the self-node identification data (step S209).

If the remote address matches with the self-node identification data, the application address detecting unit 640 determines whether there is a destination process number in the application table (step S210). If there is no destination process number in the application table, the packet transceiving unit 160, upon receiving the application packet, transmits the packet by means of the self-node identification data (step S209).

If there is a destination process number in the application table, the application address detecting unit 640 records the local addresses of the application A 610 and the application C 680 in the transmission table (step S211 through step S212).

Thereafter, when the application A 610 transmits the application packet, the packet conversion transceiving unit 650, which receives the application packet, searches the transmission table (step S213) and determines whether there is a matching entry in the transmission table (step S214).

If there is a matching entry in the transmission table, the packet conversion transceiving unit 650 transmits the application packet with the address of the same control device. The application C 680, which receives the packet, sends a packet receipt response message (application packet) (step S215), and the packet conversion transceiving unit 650, which receives the packet receipt response message, searches the transmission table (step S216), and determines whether there is a matching entry in the transmission table (step S217). If there is a matching entry in the transmission table, the packet conversion transceiving unit 650 transmits the application packet with the address of the same control device.

If there is no matching entry in the transmission table (“No” at step S214 or step S217), the packet transceiving unit 160 transmits the packet by means of the self-node identification data (step S209).

Thus, in the second embodiment, the application address detecting unit 640, in collaboration with the packet forwarding device 300, generates a transmission table, and the packet conversion transceiving unit 650, based on the application table and the transmission table, transmits the packet within the same control device by loop back, thereby enabling to efficiently carry out packet transmission within the same control device.

A packet transmission between the control devices within the same router is explained in the first embodiment, and a packet transmission within a single control device is explained in the second embodiment. Thus, a packet processing device such as a router can efficiently carry out packet transmission between the control devices as well as packet transmission within a single control device.

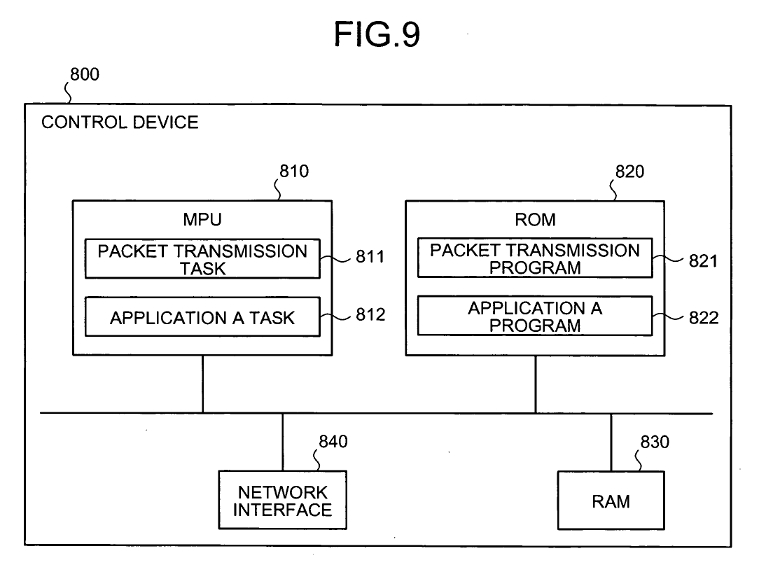

Hardware of the control device according to the first and the second embodiments is explained next. FIG. 9 is a block diagram of the hardware of the control device according to the first and the second embodiments. As shown in FIG. 9, a control device 800 includes a micro processing unit (MPU) 810, a read only memory (ROM) 820, a random access memory (RAM) 830, and a network interface 840.

The MPU 810 reads and executes programs stored in the ROM 820. The ROM 820 is a read only memory that stores programs and constants. The RAM 830 is a memory that stores results when the programs are being executed. The network interface 840 is an interface for communication with the packet transfer network 400.

A packet transmission program 821 and an application A program 822 stored in the RAM 830 are executed by the MPU 810 as a packet transmission task 811 and an application A task 812 respectively. The packet transmission program 821 is a program that realizes the units (except the applications A 110/610 and C 680) of the control device A shown in FIG. 2 and FIG. 6.

Thus, according to the invention described in claims 1 through 10, a processing overhead that occurs when a control device transceives a packet with a packet forwarding device can be eliminated, thereby enabling to efficiently carry out packet transmission within a packet processing device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A packet processing system including a plurality of control devices and a packet forwarding device that operate as a single packet forwarding device, each of the control devices executing at least one application, the packet processing system comprising:
a transmission table that stores data for a packet transmission within the packet processing system;
a determining unit that determines whether a destination for a packet specified by an application is within the packet processing system based on the transmission table; and
a transmission unit that transmits, when the determining unit determines that the destination is within the packet processing system, the packet from the application to the destination directly without using the packet forwarding device.

2. The packet processing system according to claim 1, wherein each of the control devices includes the transmission table, the determining unit, and the transmission unit.

3. The packet processing system according to claim 1, wherein the transmission table stores a virtual address specified by the application and a local address of a control device corresponding to the virtual address.

4. The packet processing system according to claim 3, wherein
the packet processing system operates as a single router, and
the virtual address includes an interface address of the router.

5. The packet processing system according to claim 3, further comprising a recording unit that records the correspondence between the virtual address and the local address of a control device in the transmission table.

6. The packet processing system according to claim 1, wherein
the transmission table stores, when a first control device executes a first application and a second control device executes a second application, data for a packet transmission between the first application and the second application,
the determining unit determines whether a destination for a packet specified by the first application falls into the second application based on the transmission table, and
the transmission unit transmits, when the determining unit determines that the destination falls into the second application, the packet from the first application to the second application directly without using the packet forwarding device.

7. The packet processing system according to claim 1, wherein
the transmission table stores, when one of the control devices executes a plurality of applications including a first application and a second application, data for a packet transmission between the first application and the second application,
the determining unit determines whether a destination for a packet specified by the first application falls into the second application based on the transmission table, and
the transmission unit transmits, when the determining unit determines that the destination falls into the second application, the packet from the first application to the second application directly without using the packet forwarding device.

8. A method of transmitting a packet in a packet processing system including a plurality of control devices and a packet forwarding device that operate as a single packet forwarding device, each of the control devices executing at least one application, the method comprising:
determining whether a destination for a packet specified by an application is within the packet processing system, based on a transmission table that stores data for a packet transmission within the packet processing system; and
transmitting, when it is determined that the destination is within the packet processing system at the determining, the packet from the application to the destination directly without using the packet forwarding device.

9. A computer-readable recording medium that stores a computer program for transmitting a packet in a packet processing system including a plurality of control devices and a packet forwarding device that operate as a single packet forwarding device, each of the control devices executing at least one application, the computer program causes a computer to execute:
determining whether a destination for a packet specified by an application is within the packet processing system, based on a transmission table that stores data for a packet transmission within the packet processing system; and
transmitting, when it is determined that the destination is within the packet processing system at the determining, the packet from the application to the destination directly without using the packet forwarding device.
